(19) United States
(12) Patent Application Publication
(10) Pub. No.: US 2021/0148710 A1
(43) Pub. Date: May 20, 2021

(54) METHODS, SYSTEMS, AND MEDIA FOR MODIFYING OPEN SPACE ACCESS USING GENERATIVE DESIGN

(71) Applicant: Sidewalk Labs LLC, New York, NY (US)

(72) Inventors: Violet Whitney, Long Island City, NY (US); Difei Chen, New York, NY (US); Douwe Osinga, New York, NY (US); Kabir Soorya, Long Island City, NY (US); Jack Amadeo, Brooklyn, NY (US); Brian Ho, New York, NY (US); Okalo Ikhena, New York, NY (US); Amanda Meurer, Brooklyn, NY (US); Samara Trilling, New York, NY (US); Dan Vanderkam, Brooklyn, NY (US)

(21) Appl. No.: 16/951,654

(22) Filed: Nov. 18, 2020

Related U.S. Application Data
(60) Provisional application No. 62/936,859, filed on Nov. 18, 2019.

(51) Int. Cl. G01C 21/32; G06F 16/29

(52) U.S. Cl. CPC G01C 21/32; G06F 16/29

(57) ABSTRACT

Methods, systems, and media for modifying open space access using generative design are provided. In some embodiments, the method comprises: receiving, using a hardware processor, map data corresponding to a geographic location; receiving, using the hardware processor, data from a plurality of sensors positioned within the geographic location; determining, using the hardware processor, a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location; causing, using the hardware processor, a user interface for reserving one of the plurality of spaces within the geographic location to be presented in connection with a map of the geographic location that is generated based on the map data; receiving, using the hardware processor, an indication that a space within the map of the geographic location is to be reserved; and updating, using the hardware processor, the user interface to indicate that the space within the map of the geographic location has been reserved while concurrently placing a reservation for the space.

### CROSS-REFERENCE TO RELATED APPLICATIONS

This application claims the benefit of U.S. Provisional Patent Application No. 62/936,859, filed Nov. 18, 2019, which is hereby incorporated by reference herein in its entirety.

### TECHNICAL FIELD

The disclosed subject matter relates to methods, systems, and media for modifying open space access using generative design.

### BACKGROUND

Many cities and other areas have public spaces that are available for use by the public, such as parks, playgrounds, recreation centers, waterfront areas, etc. These public spaces are often designed for a limited set of activities, which can become outdated over time. For example, a playground can be designed with a court for a particular sport that is popular at the time of design but becomes less popular over time. Alternatively, the use profile of a public space may change with contextual factors, such as weather. This can leave the public space underused or, in some instances, unused. Additionally, even if a public space is frequently in use, it can be difficult for people to coordinate the use of the public space. For example, a particular park may be very popular for children's birthday parties on weekends, which can cause people who want to use the park for a party to arrive early to claim a spot in the park. Coordination of public spaces such that all available public space is optimally used would waste less space and cause less frustration for people, however, it can be difficult to identify available areas.

Accordingly, it is desirable to provide new methods, systems, and media for modifying open space access using generative design.

### SUMMARY

Methods, systems, and media for modifying open space access using generative design are provided.

In accordance with some embodiments of the disclosed subject matter, a method for modifying open space access using generative design is provided, the method comprising: receiving, using a hardware processor, map data corresponding to a geographic location; receiving, using the hardware processor, data from a plurality of sensors positioned within the geographic location; determining, using the hardware processor, a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location; causing, using the hardware processor, a user interface for reserving one of the plurality of spaces within the geographic location to be presented in connection with a map of the geographic location that is generated based on the map data; receiving, using the hardware processor, an indication that a space within the map of the geographic location is to be reserved; and updating, using the hardware processor, the user interface to indicate that the space within the map of the geographic location has been reserved while concurrently placing a reservation for the space.

In some embodiments, each of the plurality of sensors is one of a microphone, a noise level sensor, a motion sensor, an image sensor, an air quality sensor, and a weather sensor.

In some embodiments, the map in the user interface is augmented with density information of people at different locations within the geographic location based on the data from the plurality of sensors positioned within the geographic location.

In some embodiments, the method further comprises: receiving a user-selected activity for reserving the space at a particular time; and determining whether one or more spaces of the plurality of spaces are suitable for the user-selected activity at the particular time based on information associated with spaces that are proximal to each space and the data from the plurality of sensors positioned within the geographic location.

In some embodiments, the one or more spaces of the plurality of spaces are determined as being suitable for the user-selected activity at the particular time based on a model trained on previous reservation information.

In some embodiments, the method further comprises determining a program use indicator for association with each space, wherein the program use indicator indicates whether the space is programmable for different program uses.

In some embodiments, the method further comprises: determining whether modular furniture is available for the space at a particular time based on the data from the plurality of sensors positioned within the geographic location; in response to determining that the modular furniture is available, presenting an indicator in the user interface that indicates availability of the modular furniture; and, in response to selecting the indicator, causing the user interface to present a list of the modular furniture for reservation at the space.

In accordance with some embodiments of the disclosed subject matter, a system for modifying open space access using generative design is provided, the system comprising a memory and a hardware processor that, when configured to execute computer executable instructions stored in the memory, is configured to: receive map data corresponding to a geographic location; receive data from a plurality of sensors positioned within the geographic location; determine a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location; cause a user interface for reserving one of the plurality of spaces within the geographic location to be presented in connection with a map of the geographic location that is generated based on the map data; receive an indication that a space within the map of the geographic location is to be reserved; and update the user interface to indicate that the space within the map of the geographic location has been reserved while concurrently placing a reservation for the space.

In accordance with some embodiments of the disclosed subject matter, a non-transitory computer-readable medium containing computer executable instructions that, when executed by a processor, cause the processor to perform a method for modifying open space access using generative design is provided, the method comprising: receiving, using a hardware processor, map data corresponding to a geographic location; receiving, using the hardware processor, data from a plurality of sensors positioned within the geographic location; determining, using the hardware processor, a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location; causing, using the hardware processor, a user interface for reserving one of the plurality of spaces within the geographic location to be presented in connection with a map of the geographic location that is generated based on the map data; receiving, using the hardware processor, an indication that a space within the map of the geographic location is to be reserved; and updating, using the hardware processor, the user interface to indicate that the space within the map of the geographic location has been reserved while concurrently placing a reservation for the space.

In accordance with some embodiments of the disclosed subject matter, a system for modifying open space access using generative design is provided, the system comprising: means for receiving map data corresponding to a geographic location; means for receiving data from a plurality of sensors positioned within the geographic location; means for determining a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location; means for causing a user interface for reserving one of the plurality of spaces within the geographic location to be presented in connection with a map of the geographic location that is generated based on the map data; means for receiving an indication that a space within the map of the geographic location is to be reserved; and means for updating the user interface to indicate that the space within the map of the geographic location has been reserved while concurrently placing a reservation for the space.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for modifying open space access using generative design in accordance with some embodiments of the disclosed subject matter.

FIGS. 2A-2E show examples of user interfaces for reserving open or public spaces in accordance with some embodiments of the disclosed subject matter.

FIGS. 3A and 3B show examples of schematic diagrams for allocating open or public spaces based on one or more activities in accordance with some embodiments of the disclosed subject matter.

FIG. 4 shows an example of a schematic diagram for allocating open or public spaces based on time of day in accordance with some embodiments of the disclosed subject matter.

FIG. 5 shows a schematic diagram of an illustrative system suitable for implementation of mechanisms described herein for modifying open space access using generative design in accordance with some embodiments of the disclosed subject matter.

FIG. 6 shows a detailed example of hardware that can be used in a server and/or a user device of FIG. 5 in accordance with some embodiments of the disclosed subject matter.

FIG. 7 shows an example of a schematic diagram for identifying modular furniture available in accordance with some embodiments of the disclosed subject matter.

### DETAILED DESCRIPTION

In accordance with various embodiments, mechanisms (which can include methods, systems, and media) for modifying open space access using generative design are provided.

In some embodiments, the mechanisms described herein can present one or more user interfaces for reserving open or public spaces. In some embodiments, the mechanisms can be used to reserve any suitable type of public space, such as a portion of a park, a playground, a court for a particular sport, a recreation center, a space at a recreation center, a picnic table, a fire pit, a room at a library, gym equipment in a park, and/or any other suitable type of public space.

In some embodiments, the mechanisms described herein can identify spaces that are available for reservation for different types of activity based on any suitable information. For example, in some embodiments, the mechanisms can identify spaces that are available for relatively loud activities based on locations of other scheduled activities. As a more particular example, in some embodiments, the mechanisms can identify spaces that are available for reservation for a party (which may be loud compared with other activities) based on the identified spaces being relatively far from spaces that have already been reserved for relatively quiet activities (e.g., a coworking space, a reading area, and/or any other suitable relatively quiet activity). As another example, in some embodiments, the mechanisms can identify spaces that are available for particular types of activities based on a time of day. As a more particular example, in some embodiments, the mechanisms can identify a particular public space as being suitable for presenting a movie if it is determined that the space is available during an evening time or a weekend time and can identify the same public space as being suitable for a playground if it is determined that the space is available during an afternoon time. In some embodiments, the mechanisms can update a user interface for reserving public spaces based on real-time or near real-time identification of available public spaces and/or an identification of public spaces suitable for particular types of activity.

In some embodiments, information received by the mechanisms can be used for any suitable purpose. For example, in some embodiments, information indicating reservations of different areas can be aggregated to allow an identification of any suitable trends, such as an identification of public spaces that are frequently used for particular activities (e.g., that a particular playground is frequently reserved for children's parties, that a particular picnic table is frequently reserved as an outdoor working space, and/or any other suitable activities). As another example, in some embodiments, information indicating reservations of different areas can be used to schedule maintenance work associated with the area. As a more particular example, in some embodiments, the information can be used to determine that a particular portion of a park is not typically occupied on weeknights, and that weeknights are therefore a suitable time for maintenance work.

Note that, in some embodiments, the mechanisms described herein can be used both during operation of a district or geographic location to identify, recommend, and reserve locations within the district for particular activities (as described above), as well as during initial design of the district. For example, in some embodiments, sensor data or other information can be used to plan space allocation for different usages or purposes within the district during design. As a more particular example, in some embodiments, particular areas within a geographic location can be identified as likely to be relatively quiet. As a specific example, an area in a center of a large park can be identified as likely to be relatively quiet. As another more particular example, in some embodiments, a park that is adjacent to an area to be used by restaurants, coffee shops, etc., can be indicated as a good candidate for hosting food festivals. As yet another more particular example, in some embodiments, a park that is adjacent to an area that is to be used to house multiple office buildings can be identified as an area through which a greenway or other pedestrian and cyclist friendly path is to be laid out. As still another more particular example, in some embodiments, sensor data that indicates weather information can be used to identify locations that tend to be particularly cold or particularly windy at different times of the year. Continuing with this example, in some embodiments, the weather information can be used during design of a district to identify locations that would be good candidates or that are likely to not be good candidates for restaurants or coffee shops with outdoor seating.

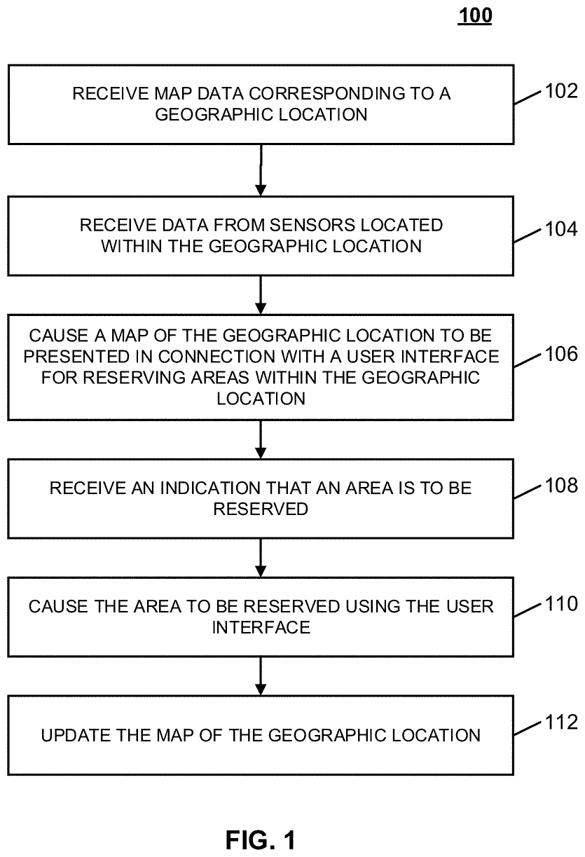

Additionally, note that, in some embodiments, although the mechanisms described below in connection with FIGS. 1, 2A-2E, 3A, and 3B generally relate to reserving locations for events such as parties, kids' activities, etc., in some embodiments, the mechanisms described herein can be used for grouping commercial tenants in commercial spaces optimally, allocating large community events optimally, and/or for any other suitable purpose(s). For example, in some embodiments, the mechanisms described herein can be used to identify two or more commercial tenants that would be likely to benefit from proximity to each other based on sensor data and/or any other suitable data. As a more particular example, in some embodiments, a book store and a coffee shop can be identified as commercial tenants that are likely to benefit from being in proximity to each other. Continuing with this example, in some embodiments, the mechanisms described herein can determine that a book store and a coffee shop are relatively good candidates to share a particular rental space (e.g., adjacent bottom floors of a mixed-use building, and/or any other suitable space), and can additionally determine that an optimal location for the book store and the coffee shop is in a location that is likely to have a lot of foot traffic based on any suitable sensor data (e.g., based on data indicating pedestrian traffic, data indicating vehicle traffic, and/or any other suitable sensor data) and/or based on geographic location data (e.g., based on a location being adjacent to a park or greenway, and/or based on any other suitable geographic location data).

As another example, in some embodiments, the mechanisms described herein can be used to optimally allocate large-scale community events, such as music festivals, food festivals, races, and/or any other suitable community events. As a more particular example, in some embodiments, the mechanisms described herein can be used to recommend a particular location (e.g., a particular park, and/or any other suitable location) as a candidate to host a particular type of community event based on a capacity of the location for hosting a particular number of people, based on forecasted weather conditions, based on a proximity of the location to public transit, based on other events occurring at the same time, and/or based on any other suitable information.

Note that, in instances where the mechanisms described herein are used for large-scale design or planning (e.g., in identifying commercial tenants that are likely to benefit from being in proximity to each other, for space allocation of areas of a district, for allocation of areas for large events, and/or any other suitable purposes), the mechanisms can be accessed in any suitable manner, such as via an Application Programming Interface (API). For example, in some embodiments, an API can be used to access sensor data, reservation data, and/or any other suitable information for one or more locations for any suitable purpose, as described below in connection with FIG. 1. In a more particular example, the mechanisms can identify a particular public space as being a flexible space that can be used for one or more purposes or needs. For example, a flexible space can include a flexible plaza that can be reconfigured by day or season. In another example, a flexible space can include an adaptable water space that can draw people to the space throughout a given year.

Turning to FIG. 1, an example 100 of a process for management of public spaces is shown in accordance with some embodiments of the disclosed subject matter. In some embodiments, blocks of process 100 can be executed by any suitable device, such as one or more servers that coordinate usage of public space.

Process 100 can begin at 102 by receiving map data corresponding to a geographic location. In some embodiments, the geographic location can correspond to any suitable parcel of land of any suitable size. In some embodiments, the map data can include any suitable information about the geographic location, such as locations of borders, locations of natural landmarks (e.g., rivers, lakes, mountains, etc.), locations of existing infrastructure (e.g., bridges, parks, buildings, etc.), and/or any other suitable information. In some embodiments, process 100 can receive the map data from any suitable entity or source. In some embodiments, the map data can be in any suitable format, such as indications of geospatial coordinates of landmarks, and/or in any other suitable format.

At 104, process 100 can receive data from sensors located within the geographic location. In some embodiments, the sensors can include any suitable type of sensors, such as microphones, motion sensors, cameras, air quality sensors, weather sensors (e.g., rain gauges, wind gauges, and/or any other suitable weather-related sensors), and/or any other suitable type of sensors. In some embodiments, process 100 can receive data that indicates any suitable information relating to a current state of areas within the geographic location. For example, in some embodiments, the data can be from one or more microphones located at different locations within the geographic location, where the data can indicate a current noise level at each location. As another example, in some embodiments, the data can be from one or more cameras that can indicate a number of people within proximity of each camera. As yet another example, in some embodiments, the data can be from one or more weather sensors that can indicate current weather conditions near each sensor (e.g., a current wind speed, a current barometric pressure, an amount of precipitation that has recently fallen, and/or any other suitable weather conditions).

At 106, process 100 can cause a map of the geographic location to be presented in connection with a user interface for reserving areas within the geographic location. In some embodiments, process 100 can generate the map of the geographic location using the map data and/or the data received from the sensors. For example, in some embodiments, process 100 can generate a map of the geographic location that includes any suitable natural landmarks or infrastructure indicated in the map data. As another example, in some embodiments, process 100 can indicate any suitable information determined based on the data from the sensors. As a more particular example, in some embodiments, process 100 can generate the map such that the map indicates current weather information based on data received from weather sensors. As another more particular example, in some embodiments, process 100 can generate the map such that the map indicates current densities of people at different locations of the map based on camera images and/or motion sensor data received by process 100. As yet another more particular example, in some embodiments, process 100 can generate the map such that the map indicates any suitable publicly available infrastructure, such as Wi-Fi access points, charging stations, electric vehicle charging stations, and/or any other suitable infrastructure.

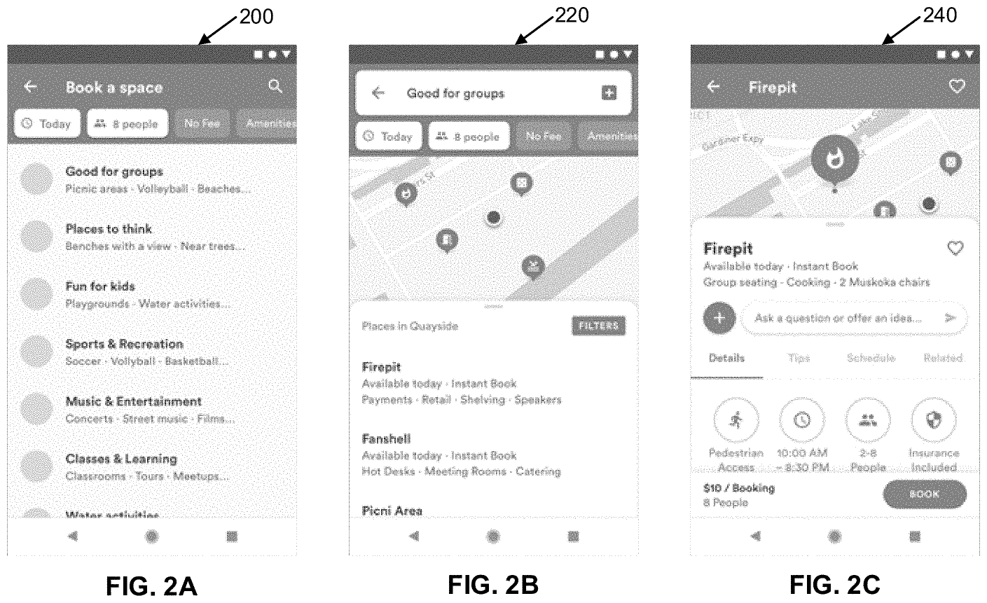

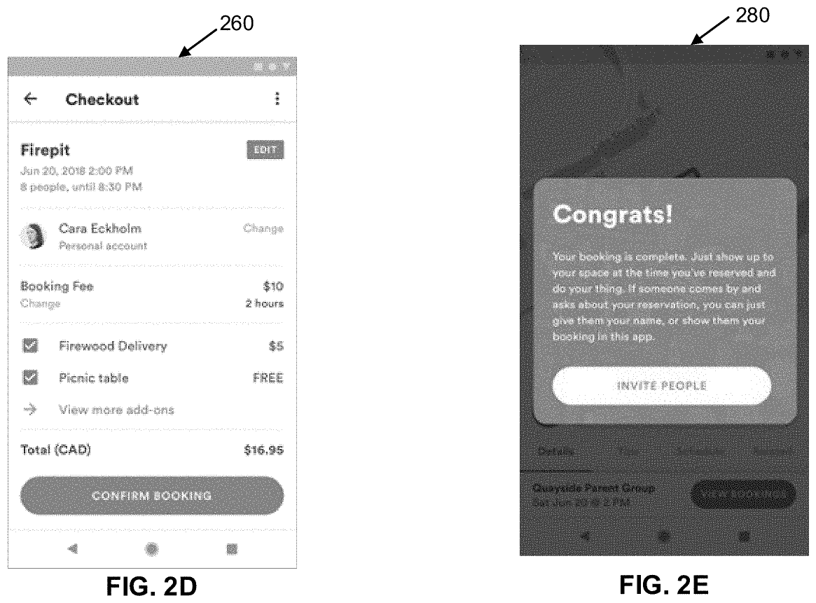

Turning to FIGS. 2A-2E, examples of user interfaces for reserving areas within the geographic location are shown in accordance with some embodiments of the disclosed subject matter. As shown in user interface 200 of FIG. 2A, in some embodiments, a user interface can be presented that allows a user to select a type of space to be reserved, such as a space that is good for groups, a space that is good for working or studying, a space that is fun for kids, etc. As shown in user interface 220 of FIG. 2B, in some embodiments, in response to a selection of a type of space (e.g., from user interface 200 of FIG. 2A), a user interface that can show available areas corresponding to the selected type of space can be presented. In some embodiments, as shown in FIG. 2B, available areas can be filtered in any suitable manner, such as based on a day the space is to be reserved for, based on a number of people the space is to be reserved for, based on a cost associated with the reservation, and/or based on any other suitable information. As shown in user interface 240 of FIG. 2C, in some embodiments, in response to a selection of a particular space (e.g., from user interface 220 of FIG. 2B), a user interface that can show additional information about the selected space can be presented. In some embodiments, any suitable information can be included, such as information about accessibility, a time associated with the reservation, a fee associated with the reservation, and/or any other suitable information.

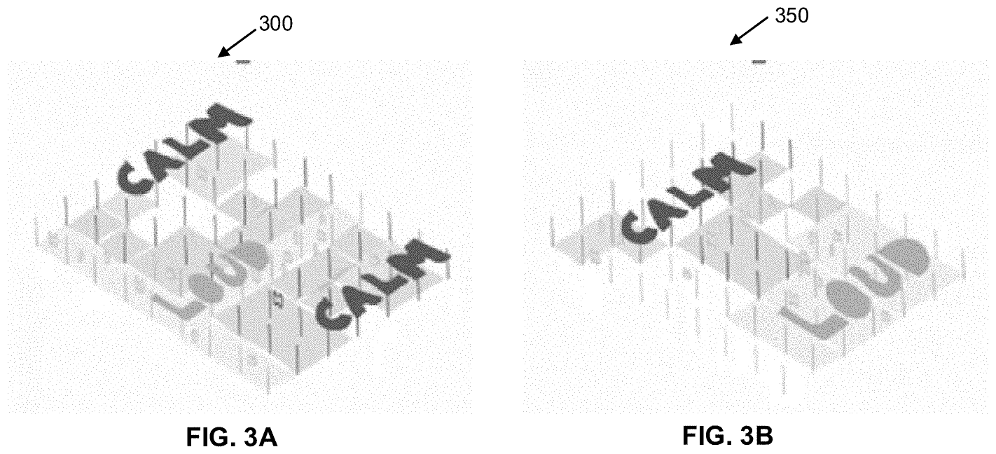

Note that, in some embodiments, spaces that are available for reservation (e.g., as indicated in user interface 220 of FIG. 2B) can be determined by process 100 using any suitable information and technique(s). For example, in some embodiments, process 100 can identify spaces that are available for reservation for particular types of activity based on proximity of a space to other spaces that are scheduled to be used. As a more particular example, in some embodiments, process 100 can identify areas that are available for reservation for groups and/or activities that are relatively noisy such that the identified available areas are adjacent to other areas that are scheduled to also be used for relatively noisy activities. As a specific example, in an instance where process 100 determines that a particular portion of a park has already been reserved for a party, process 100 can determine that an adjacent area of the park is to be listed as available for other relatively noisy activities and/or activities in which noise will be tolerated. As another specific example, in an instance where process 100 determines that a particular portion of a park has already been reserved for a relatively quiet activity (e.g., as an outdoor coworking space, and/or any other suitable quiet activity), process 100 can determine that an adjacent area of the park is not to be listed as available for relatively noisy events, such as a concert or party. Note that, in some embodiments, process 100 can predict a noise-level of an activity based on any suitable information, such as a number of people associated with a reservation of an area, and/or any other suitable information. FIGS. 3A and 3B show examples 300 and 350, respectively, of diagrams for space allocation based on activity type.

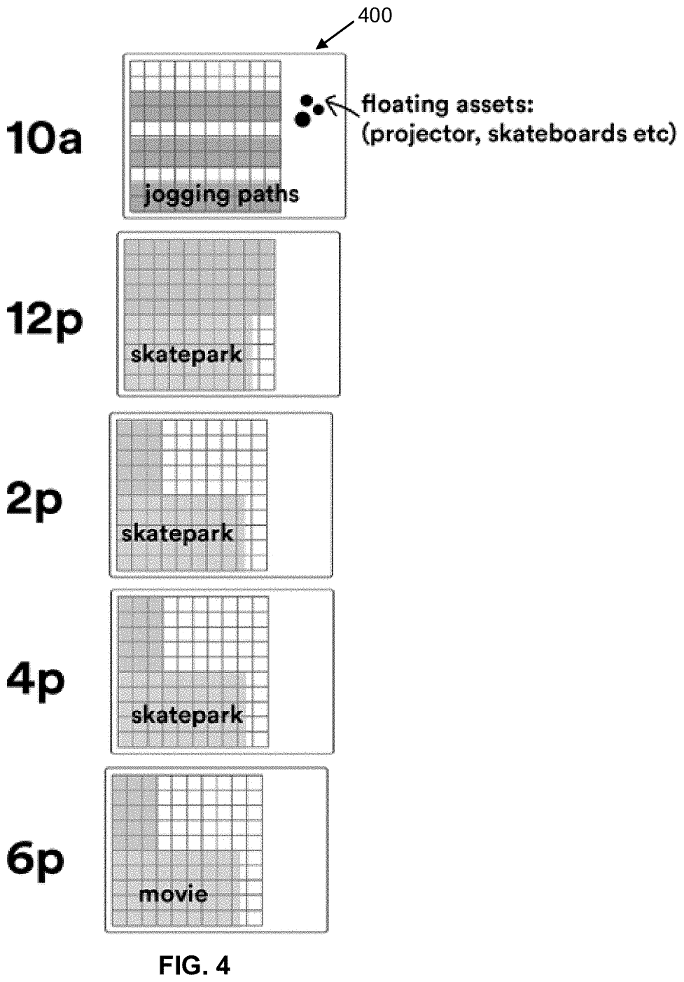

As another example, in some embodiments, process 100 can identify spaces that are available based on a time of day. A more particular example of a diagram 400 for space allocation based on time of day is shown in FIG. 4. As illustrated, in some embodiments, a portion of a geographic location (e.g., a park, a portion of a park, and/or any other suitable portion) can be reconfigured throughout a day to serve different purposes. For example, in some embodiments, a park can be configured to include jogging paths during morning hours to accommodate morning exercisers, a skatepark during afternoon hours to accommodate children, and a theatre area during evening hours to allow a movie to be shown. Referring back to FIG. 1, in some embodiments, process 100 can identify spaces available for reservation based on time of day and based on information provided by a user. For example, in some embodiments, process 100 can identify available spaces that are suitable for a particular type of activity (e.g., a party, kids' activities, a work space, and/or any other suitable activity) that has been indicated using user interface 200 of FIG. 2A and based on a time of day. As a more particular example, in an instance where a user of user interface 200 has indicated that the user wants to reserve a space for a movie at 6 p.m., process 100 can determine that a particular portion of a park will be a suitable space for presenting a movie at 6 p.m., as shown in FIG. 4.

Note that, in some embodiments, process 100 can use data collected from previous reservations to update a model that identifies spaces that are suitable for particular activities based on a type of activity and/or a time of day. For example, in some embodiments, process 100 can determine times of day that users typically reserve particular spaces for particular types of activities. As a more particular example, in some embodiments, process 100 can use prior reservation data to determine that users typically reserve spaces for parties on weekend days. As another more particular example, in some embodiments, process 100 can use prior reservation data to determine that users typically reserve spaces for parties in locations away from busy roads. As yet another more particular example, in some embodiments, process 100 can use prior reservation data to determine that users typically reserve spaces for coworking or outdoor office space during daytime hours on weekdays. As still another more particular example, in some embodiments, process 100 can use prior reservation data to determine that users typically reserve spaces for relatively quiet activities that are away from areas typically used to host parties. In some embodiments, process 100 can use any suitable algorithm(s) to classify areas within the geographic locations as suitable for particular activities and/or suitable for particular activities based on time of day. For example, in some embodiments, process 100 can use any suitable machine learning algorithm to identify a trend of prior reservation data.

Note also that, in some embodiments, process 100 can store an indicator for each space that indicates whether a particular space is programmable or flexible for different program uses. For example, based on equipment needs, adjacency information regarding programs that generally co-habitate well together, weather information, timing information, and/or other program information, process 100 can store one or more indicators describing a program use for the particular space. Additionally, in some embodiments, each space can be associated with one or more conditions under which the space is flexible. For example, in some embodiments, an outdoor location can be indicated as programmable or flexible under particular weather conditions (e.g., when outdoor temperature is within a particular range, when it is not raining or snowing, etc.) and during particular timing conditions (e.g., on weekends, between 6 p.m. and 10 p.m., and/or any other suitable timing conditions.

Additionally, note that, in some embodiments, process 100 can present information indicating modular furniture that is available in particular locations. In some embodiments, the modular furniture can include any suitable furniture, coverings, decorations etc., such as modular benches, picnic tables, awnings that provide shade, sprinklers or other water features, trees or shrubbery that can be moved, and/or any other suitable modular furniture.

In some embodiments, process 100 can determine whether any suitable modular furniture are available for a particular location at a particular time prior to presenting information indicating the availability of the modular furniture. For example, for a particular location (e.g., a particular location included in FIGS. 2B or 2C), process 100 can determine whether modular furniture is available for the location based on a time of day, forecasted weather conditions, forecasted traffic or pedestrian conditions, and/or based on any other suitable information. As a more particular example, for an outdoor location such as a park, process 100 can determine that particular types of modular furniture (e.g., benches, picnic tables, etc.) are available based on a predicted amount of foot traffic. As a specific example, process 100 can determine that benches and/or picnic tables are to be indicated as available in response to determining that historical sensor data predicts a relatively high amount of foot traffic in the park at the time the park is to be reserved for. As another more particular example, process 100 can determine that particular types of modular furniture that provide shade or other weather cover are to be indicated as available for outdoor locations based on a weather forecast for the outdoor location (e.g., that awnings are to be indicated as available in response to determining that the forecast indicates relatively hot or rainy weather, and/or any other suitable weather forecast). As another example, in some embodiments, process 100 can identify modular furniture that is to be indicated as available based on a type of event. As a more particular example, in instances in which a type of event indicates a relatively large gathering of people in a particular location (e.g., for a music festival, and/or for any other suitable type of event), process 100 can identify types of modular furniture that provide seating for large numbers of people and/or that provide weather protection (e.g., based on a weather forecast). As a specific example, process 100 can determine that space heaters are to be indicated as available in connection with an event in an outdoor location in connection with a weather forecast for the outdoor location that indicates that temperatures are predicted to be below a predetermined threshold. Note that, although not shown in in FIGS. 2B and 2C, in some embodiments, process 100 can cause indications of available modular furniture to be shown in connection with each indicated location. For example, referring to FIG. 2B, in some embodiments, process 100 can cause a selectable icon to be presented in connection with each location (e.g., “Firepit,” “Fanshell,” “Picnic Area,” etc.) that, when selected, causes a list of available modular furniture to be presented.

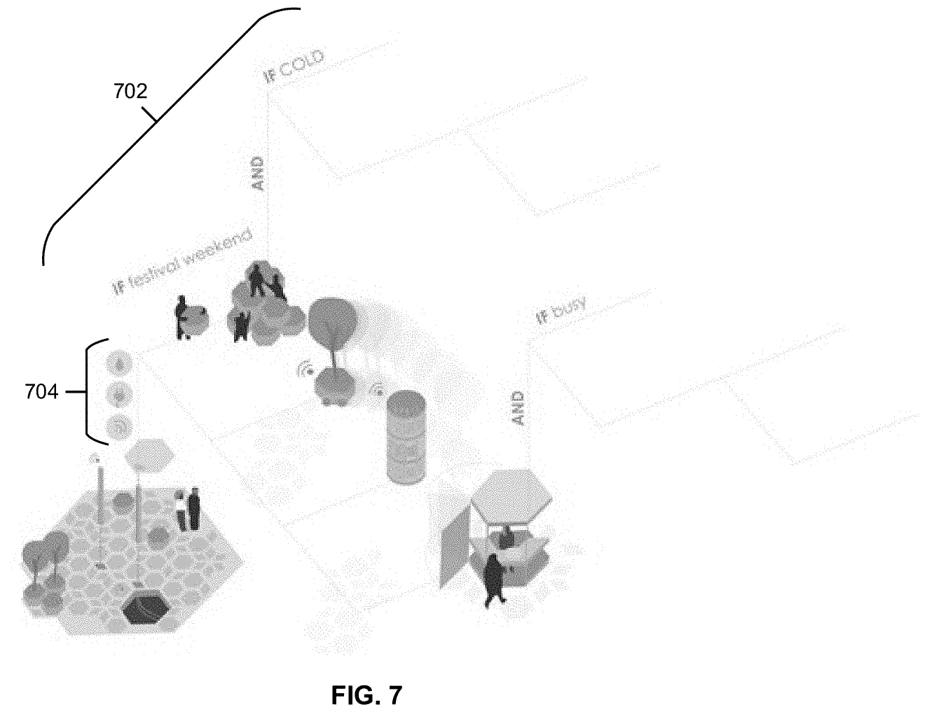

Note that, in some embodiments, the mechanisms described herein can identify modular furniture or other infrastructure that is to be made available or that is to be recommended based on one or more conditions. Turning to FIG. 7, an example of a schematic diagram for identifying modular furniture is shown in accordance with some embodiments of the disclosed subject matter. As illustrated in FIG. 7, in some embodiments, one or more conditions can be specified for a particular location, such as a park or a particular portion of a park, a plaza, and/or any other suitable type of location. As a more particular example, as shown in FIG. 7, the conditions (such as conditions 702 of FIG. 7) can include conditions related to weather (e.g., “if cold,” “if hot,” “if rainy,” and/or any other suitable type of event), conditions related to an event that is to occur at the location at a particular time (e.g., “if festival weekend,” and/or any other suitable type of event), conditions related to a number of people expected (e.g., “if busy,” “if more than 100 people,” and/or any other suitable metric), and/or any other suitable conditions. Additionally, in some embodiments, a group of infrastructure 704 can be specified that is to be made available or that is to be recommended (e.g., recommended to a planner of an event, and/or to any other suitable person or entity) in response to a determination that conditions 702 have been satisfied. For example, as shown in FIG. 7, infrastructure 704 can include Wi-Fi hotspots, modular benches or picnic tables, furniture that includes electrical outlets, awnings or other coverings, modular trees, and/or any other suitable type of furniture or infrastructure. In some embodiments, conditions 702 and infrastructure 704 can be specified by any suitable user(s) or entities. For example, in some embodiments, conditions 702 and/or infrastructure 704 can be specified by an organization that provides oversight for the location to which conditions 702 are applied.

Referring back to FIG. 1, at 108, process 100 can receive an indication that an area is to be reserved. For example, referring to user interface 260 of FIG. 2D, process 100 can receive an indication that a particular area is to be reserved for a predetermined number of people at a predetermined date and time.

Referring back to FIG. 1, at 110, process 100 can cause the area to be reserved. For example, in some embodiments, in response to receiving a confirmation of the reservation, process 100 can cause user interface 280 of FIG. 2E to be presented, which can include a message that confirms that the area has been reserved. In some embodiments, process 100 can cause the area to be reserved in any suitable manner. For example, in some embodiments, process 100 can update a database that stores indications of statuses of different areas within the geographic location at different times to indicate the reservation. As another example, in some embodiments, process 100 can process a fee required to reserve the area in any suitable manner (e.g., using any suitable online payment system, and/or in any other suitable manner).

At 112, process 100 can update the map of the geographic location. For example, in some embodiments, process 100 can update the map and/or a user interface for reserving areas that is presented in connection with the map to indicate that the reserved area is no longer available for reservation at the time and date the area has been reserved. As another example, in some embodiments, process 100 can update other available areas based on a type of activity associated with the reservation. As a more particular example, in an instance where the reservation is associated with a party or other noisy activity, process 100 can update the map to indicate that adjacent areas are no longer available for reservation for relatively quiet activities (e.g., to group noisy activities together). As another more particular example, in an instance where the reservation is associated with a quiet activity (e.g., an outdoor working space, and/or any other suitable quiet activity), process 100 can update the map to indicate that adjacent areas are no longer available for reservation for relatively noisy activities (e.g., parties, concerts, etc.).

Note that, in some embodiments, process 100 can provide an output or provide any suitable information in any suitable manner. For example, as described above in connection with blocks 110 and 112, process 100 can update a user interface or a map presented in a user interface. As another example, in some embodiments, any suitable information from process 100 can be provided to an application via an Application Programming Interface (API). As a more particular example, in some embodiments, in an instance in which a user (e.g., a party planner, a resident of a location, and/or any other suitable user) has reserved a particular location for an event, process 100 can use an API to transmit a notification to the user in response to determining that particular conditions have changed, and, in some embodiments, recommending an alternate location for the event. As a more particular example, in an instance in which a user has reserved an outdoor location for an event and in which sensor data or weather forecast information indicates that weather conditions will be unsuitable for an outdoor event during the reserved time, process 100 can transmit a notification (e.g., a push notification, a text message, an e-mail message, and/or any other suitable notification) to the user. Continuing with this example, in some embodiments, process 100 can identify available alternate locations that are suitable for the event based on any suitable criteria, as described above in connection with blocks 104 and 106. As a more particular example, in an instance in which the reserved event is a party, and in which the original reserved location is an outdoor location which is no longer suitable due to unfavorable weather conditions, process 100 can identify one or more indoor locations suitable for a party, and can include indications of the identified locations in the notifications.

As another more particular example, in some embodiments, an entity such as a business or other organization can interact with the functions performed by process 100 via an API that allows the business or organization to access any suitable information (e.g., sensor information, reservation information, and/or any other suitable information) for any suitable purpose. For example, in some embodiments, the API can allow a business to retrieve sensor data indicating vehicle traffic or pedestrian traffic at different times of day or days of the week at one or more locations to determine an optimal location for a shop or other business. As a more particular example, in some embodiments, the API can allow a user to select (e.g., via any suitable user interface, and/or in any other suitable manner) one or more locations and one or more types of data associated with each of the selected locations (e.g., traffic data at each location, reservation information for each location, weather data at each location, reservation cancellation information at each location, and/or any other suitable type of data), and the API can then provide the requested data for each of the locations in any suitable manner (e.g., via a user interface, as a spreadsheet, and/or in any other suitable manner).

Additionally, note that, in some embodiments, reservation information and other data (e.g., sensor data, and/or any other suitable data) collected by process 100 can be used for any other suitable purpose. For example, in some embodiments, reservation information and other data can be used to identify areas within the geographic location suitable for particular types of buildings. As a more particular example, in some embodiments, reservation information can be used to determine that a suitable location for a coffee shop is within a predetermined proximity to an area that is frequently reserved for coworking spaces.

As another example, in some embodiments, reservation information, sensor data, and/or any other suitable data can be used to provide feedback for any suitable portions of process 100 that are used to provide recommendations for usage of different areas. As a more particular example, in an instance in which a particular park or portion of a particular park is frequently recommended and subsequently reserved for a particular activity (e.g., a kids' activity, a food festival, and/or any other suitable type of activity), the reservation information can be used to determine that the particular park or the portion of the particular park is suitable for the activity. As another more particular example, in an instance in which a particular area is recommended for a particular activity but in which the area is not reserved for the activity subsequent to the recommendation, the reservation information can be used by process 100 to determine that the particular area is not to be recommended for the particular activity in the future. As yet another more particular example, in some embodiments, sensor information can be combined with reservation information to provide feedback for determining recommendations. As a specific example, in an instance in which reservations are frequently canceled in a particular location (e.g., an outdoor location, locations near water, and/or any other suitable locations) in connection with particular sensor data that indicate weather conditions (weather readings indicating particular temperatures, weather readings indicating particular wind conditions, and/or any other suitable sensor readings), the sensor information and the reservation information can be used to determine that particular types of locations (e.g., outdoor locations, and/or any other suitable type of locations) are not to be recommended at times that sensor readings indicate particular weather conditions (e.g., that the weather is particularly cold or windy, and/or any other suitable conditions).

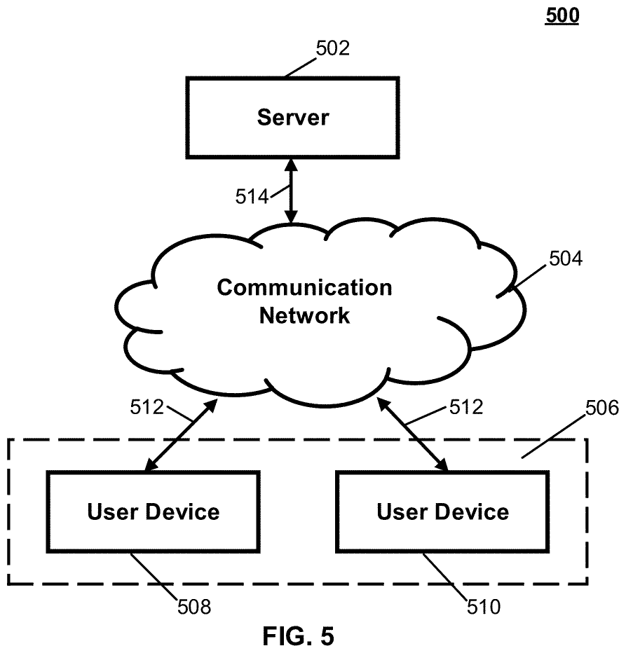

Turning to FIG. 5, an example 500 of hardware for modifying open space access using generative design that can be used in accordance with some embodiments of the disclosed subject matter is shown. As illustrated, hardware 500 can include a server 502, a communication network 504, and/or one or more user devices 506, such as user devices 508 and 510.

Server 502 can be any suitable server(s) for storing information, data, programs, maps, and/or any other suitable content. For example, in some embodiments, server 502 can store map data used for generating a map of a geographic location. As another example, in some embodiments, server 502 can receive data from sensors located within a geographic location. As yet another example, in some embodiments, server 502 can cause a user interface that can be used for reserving areas within a geographic location to be presented on a user device.

Communication network 504 can be any suitable combination of one or more wired and/or wireless networks in some embodiments. For example, communication network 504 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 506 can be connected by one or more communications links (e.g., communications links 512) to communication network 504 that can be linked via one or more communications links (e.g., communications links 514) to server 502. The communications links can be any communications links suitable for communicating data among user devices 506 and server 502 such as network links, dial-up links, wireless links, hard-wired links, any other suitable communications links, or any suitable combination of such links.

User devices 506 can include any one or more user devices suitable for presenting a user interface for reserving an area of a geographic location, and/or performing any other suitable functions. In some embodiments, user devices 506 can include any suitable type(s) of user devices. For example, in some embodiments, user devices 506 can include a mobile phone, a tablet computer, a laptop computer, a desktop computer, and/or any other suitable type of user device.

Although server 502 is illustrated as one device, the functions performed by server 502 can be performed using any suitable number of devices in some embodiments. For example, in some embodiments, multiple devices can be used to implement the functions performed by server 502.

Although two user devices 508 and 510 are shown in FIG. 5 to avoid over-complicating the figure, any suitable number of user devices, and/or any suitable types of user devices, can be used in some embodiments.

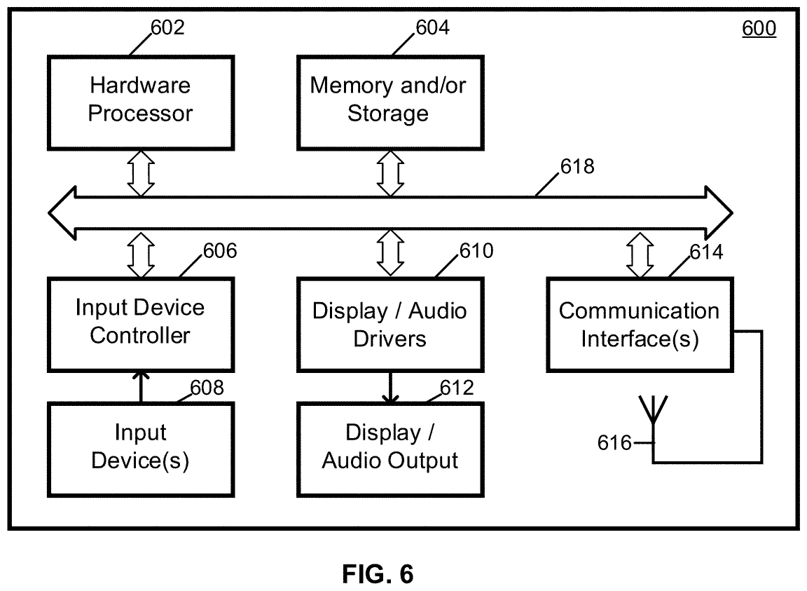

Server 502 and user devices 506 can be implemented using any suitable hardware in some embodiments. For example, in some embodiments, devices 502 and 506 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 600 of FIG. 6, such hardware can include hardware processor 602, memory and/or storage 604, an input device controller 606, an input device 608, display/audio drivers 610, display and audio output circuitry 612, communication interface(s) 614, an antenna 616, and a bus 618.

Hardware processor 602 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 602 can be controlled by a server program stored in memory and/or storage of a server, such as server 502. For example, in some embodiments, hardware process 602 can cause server 502 to receive data from sensors in a geographic location, update a map of the geographic location based on the received data, receive an indication that an area of the geographic location is to be reserved by a user of a user device, and/or perform any other suitable functions.

Memory and/or storage 604 can be any suitable memory and/or storage for storing programs, data, and/or any other suitable information in some embodiments. For example, memory and/or storage 604 can include random access memory, read-only memory, flash memory, hard disk storage, optical media, and/or any other suitable memory.

Input device controller 606 can be any suitable circuitry for controlling and receiving input from one or more input devices 608 in some embodiments. For example, input device controller 606 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 610 can be any suitable circuitry for controlling and driving output to one or more display/audio output devices 612 in some embodiments. For example, display/audio drivers 610 can be circuitry for driving a touchscreen, a flat-panel display, a cathode ray tube display, a projector, a speaker or speakers, and/or any other suitable display and/or presentation devices.

Communication interface(s) 614 can be any suitable circuitry for interfacing with one or more communication networks (e.g., computer network 504). For example, interface(s) 614 can include network interface card circuitry, wireless communication circuitry, and/or any other suitable type of communication network circuitry.

Antenna 616 can be any suitable one or more antennas for wirelessly communicating with a communication network (e.g., communication network 504) in some embodiments. In some embodiments, antenna 616 can be omitted.

Bus 618 can be any suitable mechanism for communicating between two or more components 602, 604, 606, 610, and 414 in some embodiments.

Any other suitable components can be included in hardware 600 in accordance with some embodiments.

In some embodiments, at least some of the above described blocks of the process of FIG. 1 can be executed or performed in any order or sequence not limited to the order and sequence shown in and described in connection with the figures. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for modifying open space access using generative design are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for modifying open space access using generative design, the method comprising:
receiving, using a hardware processor, map data corresponding to a geographic location;
receiving, using the hardware processor, data from a plurality of sensors positioned within the geographic location;
determining, using the hardware processor, a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location;
causing, using the hardware processor, a user interface for reserving one of the plurality of spaces within the geographic location to be presented in connection with a map of the geographic location that is generated based on the map data;
receiving, using the hardware processor, an indication that a space within the map of the geographic location is to be reserved; and
updating, using the hardware processor, the user interface to indicate that the space within the map of the geographic location has been reserved while concurrently placing a reservation for the space.

2. The method of claim 1, wherein each of the plurality of sensors is one of a microphone, a noise level sensor, a motion sensor, an image sensor, an air quality sensor, and a weather sensor.

3. The method of claim 1, wherein the map in the user interface is augmented with density information of people at different locations within the geographic location based on the data from the plurality of sensors positioned within the geographic location.

4. The method of claim 1, further comprising:
receiving a user-selected activity for reserving the space at a particular time; and
determining whether one or more spaces of the plurality of spaces are suitable for the user-selected activity at the particular time based on information associated with spaces that are proximal to each space and the data from the plurality of sensors positioned within the geographic location.

5. The method of claim 4, wherein the one or more spaces of the plurality of spaces are determined as being suitable for the user-selected activity at the particular time based on a model trained on previous reservation information.

6. The method of claim 1, further comprising determining a program use indicator for association with each space, wherein the program use indicator indicates whether the space is programmable for different program uses.

7. The method of claim 1, further comprising:
determining whether modular furniture is available for the space at a particular time based on the data from the plurality of sensors positioned within the geographic location;
in response to determining that the modular furniture is available, presenting an indicator in the user interface that indicates availability of the modular furniture; and
in response to selecting the indicator, causing the user interface to present a list of the modular furniture for reservation at the space.

8. A system for modifying open space access using generative design, the system comprising:
a memory; and
a hardware processor that, when configured to execute computer executable instructions stored in the memory, is configured to:
receive map data corresponding to a geographic location;
receive data from a plurality of sensors positioned within the geographic location;
determine a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location;
cause a user interface for reserving one of the plurality of spaces within the geographic location to be presented in connection with a map of the geographic location that is generated based on the map data;
receive an indication that a space within the map of the geographic location is to be reserved; and
update the user interface to indicate that the space within the map of the geographic location has been reserved while concurrently placing a reservation for the space.

9. The system of claim 8, wherein each of the plurality of sensors is one of a microphone, a noise level sensor, a motion sensor, an image sensor, an air quality sensor, and a weather sensor.

10. The system of claim 8, wherein the map in the user interface is augmented with density information of people at different locations within the geographic location based on the data from the plurality of sensors positioned within the geographic location.

11. The system of claim 8, wherein the hardware processor is further configured to:
receive a user-selected activity for reserving the space at a particular time; and
determine whether one or more spaces of the plurality of spaces are suitable for the user-selected activity at the particular time based on information associated with spaces that are proximal to each space and the data from the plurality of sensors positioned within the geographic location.

12. The system of claim 11, wherein the one or more spaces of the plurality of spaces are determined as being suitable for the user-selected activity at the particular time based on a model trained on previous reservation information.

13. The system of claim 8, wherein the hardware processor is further configured to determine a program use indicator for association with each space, wherein the program use indicator indicates whether the space is programmable for different program uses.

14. The system of claim 8, wherein the hardware processor is further configured to:
determine whether modular furniture is available for the space at a particular time based on the data from the plurality of sensors positioned within the geographic location;
in response to determining that the modular furniture is available, present an indicator in the user interface that indicates availability of the modular furniture; and
in response to selecting the indicator, cause the user interface to present a list of the modular furniture for reservation at the space.

15. A non-transitory computer-readable medium containing computer executable instructions that, when executed by a processor, cause the processor to perform a method for modifying open space access using generative design, the method comprising:
receiving, using a hardware processor, map data corresponding to a geographic location;
receiving, using the hardware processor, data from a plurality of sensors positioned within the geographic location;
determining, using the hardware processor, a plurality of spaces within the geographic location that are available for reservations, wherein each space is associated with an activity type from a plurality of activity types and wherein the activity type is selected based on information associated with spaces that are proximal to each space and the data from the plurality of sensors positioned within the geographic location;
causing, using the hardware processor, a user interface for reserving one of the plurality of spaces within the geographic location to be presented in connection with a map of the geographic location that is generated based on the map data;
receiving, using the hardware processor, an indication that a space within the map of the geographic location is to be reserved; and
updating, using the hardware processor, the user interface to indicate that the space within the map of the geographic location has been reserved while concurrently placing a reservation for the space.

16. The non-transitory computer-readable medium of claim 15, wherein each of the plurality of sensors is one of a microphone, a noise level sensor, a motion sensor, an image sensor, an air quality sensor, and a weather sensor.

17. The non-transitory computer-readable medium of claim 15, wherein the map in the user interface is augmented with density information of people at different locations within the geographic location based on the data from the plurality of sensors positioned within the geographic location.

18. The non-transitory computer-readable medium of claim 15, wherein the method further comprises:
receiving a user-selected activity for reserving the space at a particular time; and
determining whether one or more spaces of the plurality of spaces are suitable for the user-selected activity at the particular time based on information associated with spaces that are proximal to each space and the data from the plurality of sensors positioned within the geographic location.

19. The non-transitory computer-readable medium of claim 18, wherein the one or more spaces of the plurality of spaces are determined as being suitable for the user-selected activity at the particular time based on a model trained on previous reservation information.

20. The non-transitory computer-readable medium of claim 15, wherein the method further comprises determining a program use indicator for association with each space, wherein the program use indicator indicates whether the space is programmable for different program uses.

21. The non-transitory computer-readable medium of claim 15, wherein the method further comprises:
determining whether modular furniture is available for the space at a particular time based on the data from the plurality of sensors positioned within the geographic location;
in response to determining that the modular furniture is available, presenting an indicator in the user interface that indicates availability of the modular furniture; and
in response to selecting the indicator, causing the user interface to present a list of the modular furniture for reservation at the space.
